(19) United States
(12) Patent Application Publication
(10) Pub. No.: US 2020/0344984 A1
(43) Pub. Date: Nov. 5, 2020

(54) Fishing Lure

(71) Applicant: Michael Burns, Garden City, KS (US)

(72) Inventor: Michael Burns, Garden City, KS (US)

(21) Appl. No.: 16/400,525

(22) Filed: May 1, 2019

(51) Int. Cl. A01K 85/00; A01K 93/00; A01K 83/06

(52) U.S. Cl. CPC A01K 85/00; A01K 83/06; A01K 93/00

(57) ABSTRACT

A fishing lure for avoiding snags and attracting a target fish includes a shell that defines an interior space. The shell, which is fish shaped, is water tight so that the shell is buoyant. The shell is configured to float above objects that are positioned on a bed of a body of water. A ring that is coupled to and extends from a tail end of the shell is configured to couple the shell to a leader. A hook that is coupled to and extends from a mouth end of the shell is configured to couple to a bait and to hook a target fish.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relate to lures and more particularly pertains to a new lure for avoiding snags and attracting a target fish.

### BRIEF SUMMARY OF THE INVENTION

An embodiment of the disclosure meets the needs presented above by generally comprising a shell that defines an interior space. The shell, which is fish shaped, is water tight so that the shell is buoyant. The shell is configured to float above objects that are positioned on a bed of a body of water. A ring that is coupled to and extends from a tail end of the shell is configured to couple the shell to a leader. A hook that is coupled to and extends from a mouth end of the shell is configured to couple to a bait and to hook a target fish.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a fishing lure according to an embodiment of the disclosure.

FIG. 2 is a tail end view of an embodiment of the disclosure.

FIG. 3 is a bottom view of an embodiment of the disclosure.

FIG. 4 is a side view of an embodiment of the disclosure.

FIG. 5 is a front view of an embodiment of the disclosure.

### DETAILED DESCRIPTION OF THE INVENTION

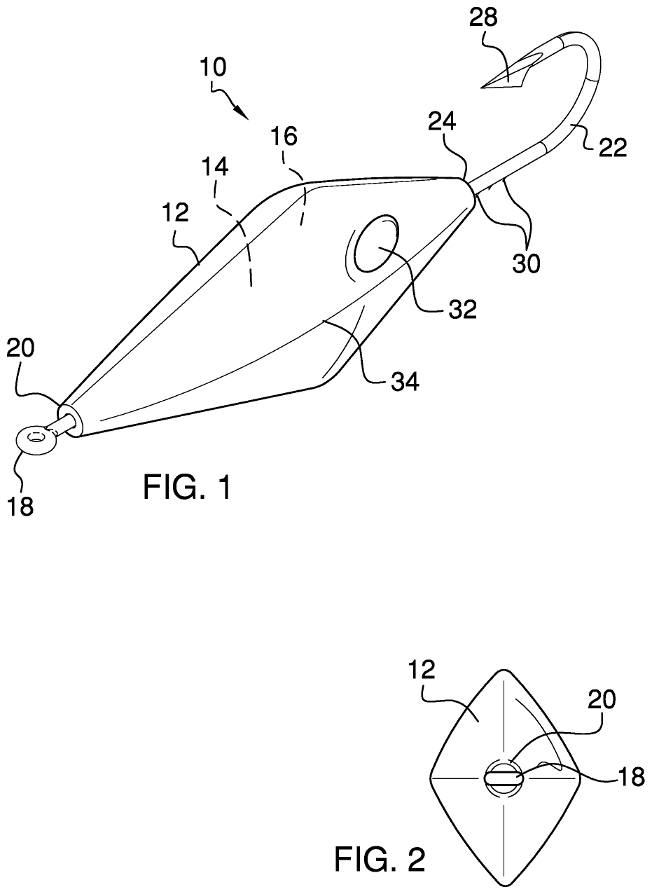

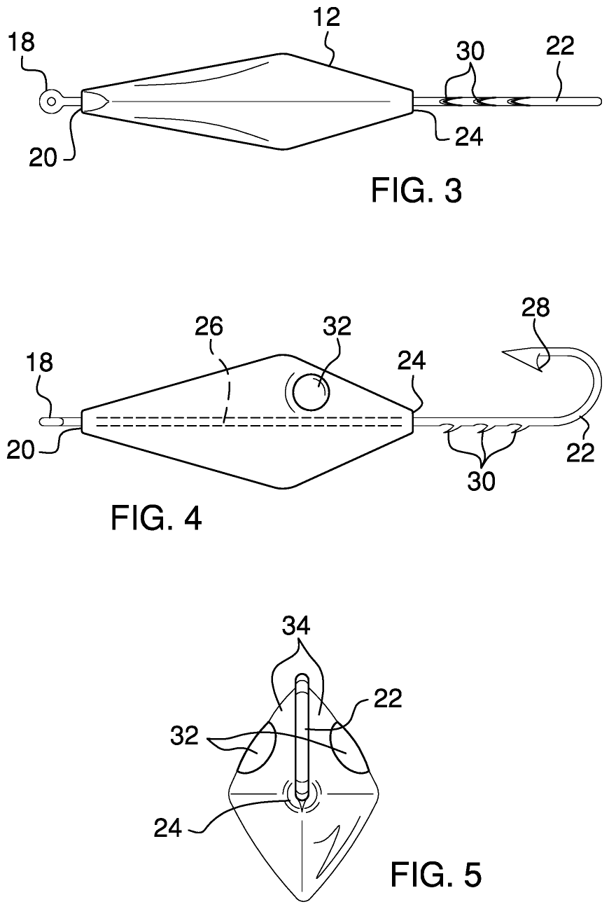

With reference now to the drawings, and in particular to FIGS. 1 through 5 thereof, a new lure embodying the principles and concepts of an embodiment of the disclosure and generally designated by the reference numeral 10 will be described.

As best illustrated in FIGS. 1 through 5, the fishing lure 10 generally comprises a shell 12 that defines an interior space 14. The shell 12, which is fish shaped, is water tight so that the shell 12 is buoyant and configured to float above objects that are positioned on a bed of a body of water. The buoyancy of the shell 12 helps to prevent the lure 10 from contacting and potentially snagging the objects on the bed, such as moss, branches, and rocks. As will become apparent below, the shell 12 being fish shaped is an important component of the utility of the lure 10. The shell 12 can have a variety of fish shapes, including elongated fish shaped, round fish shaped, oblong fish shaped, and curved fish shaped.

The shell 12 comprises at least one of paint, shellac, plastic, and the like. The shell 12 is at least one of brightly colored and reflective so that the shell 12 is configured to attract a target fish. The shell 12 is at least one of white colored, silver colored, yellow colored, blue colored, violet colored, and green colored.

A filler 16 is positioned in and substantially occupies the interior space 14. The filler 16 comprises rigid foamed elastomer, or the like, so that the shell 12 is buoyant and configured to float above the objects that are positioned on the bed of the body of water. The filler 16 also serves to rigidify the shell 12.

A ring 18 that is coupled to and extends from a tail end 20 of the shell 12 is configured to couple the shell 12 to a leader. A hook 22 that is coupled to and extends from a mouth end 24 of the shell 12 is configured to couple to a bait and to hook the target fish. A shank 26 that is positioned through the shell 12 is coupled to and extends between the hook 22 and the ring 18.

A typical prior art lure comprises one or more hooks that are coupled to and extend from at least one of a rear end, sides, bottom, and top of the prior art lure, while the leader and a fishing line would extend from a forward end of the prior art lure. A distinguishing feature of the present invention is the hook 22 being coupled to and extending from the mouth end 24 of the shell 12. The hook 22 of the present invention positions the bait near the mouth end 24 of the shell 12, thus the shell 12 mimics a small (bait) fish eating the bait that is positioned on the hook 22, which attracts the target fish.

A first barb 28 that is coupled to and extends from the hook 22 distal to the mouth end 24 of the shell 12 is configured to couple to the target fish to retain the target fish on the hook 22. A plurality of retainer barbs 30 that is coupled to and extends from the hook 22 proximate to the mouth end 24 of the shell 12 is configured to retain the bait on the hook 22 proximate to the mouth end 24 of the shell 12.

The lure 10 also comprises a pair of protrusions 32, which are arcuate. Each protrusion 32 is coupled to the shell 12 and is positioned a respective opposing side 34 of the shell 12 proximate to the mouth end 24 so that the protrusions 30 are configured to mimic eyes of a fish. The protrusions 32 are red colored so that the protrusions 32 are configured to agitate the target fish, thereby increasing the probability of the target fish attacking the lure 10 and being hooked on the hook 22.

In use, the lure 10 is coupled to the leader via the ring 18, and the leader is coupled to a fishing line. A bait is positioned on the hook 22 and the fishing line is used to lower the lure 10 into the body of water. The buoyancy of the shell 12 keeps the shell 12 and hook 22 from snagging on the objects that are positioned on the bed of the body of water. The appearance of the shell 12 and the mimicking of a small fish eating bait attracts the target fish, which is agitated by the protrusions 30 on the shell 12 and thus is likely to attack the lure and to be hooked on the hook 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing lure comprising:
a shell defining an interior space, the shell being fish shaped, the shell being water tight such that the shell is buoyant wherein the shell is configured for floating above objects positioned on a bed of a body of water;
a ring coupled to and extending from a tail end of the shell wherein the ring is configured for coupling the shell to a leader; and
a hook coupled to and extending from a mouth end of the shell such that the hook is configured for coupling to a bait and for hooking a target fish.

2. The lure of claim 1, further including the shell comprising at least one of paint, shellac, and plastic.

3. The lure of claim 1, further including the shell being at least one of brightly colored and reflective such that the shell is configured for attracting the target fish.

4. The lure of claim 3, further including the shell being at least one of white colored, silver colored, yellow colored, blue colored, violet colored, and green colored.

5. The lure of claim 1, further including a filler positioned in and substantially occupying the interior space, the filler comprising rigid foamed elastomer such that the shell is buoyant wherein the shell is configured for floating above the objects positioned on the bed of the body of water.

6. The lure of claim 1, further including a shank positioned through the shell, the shank being coupled to and extending between the hook and the ring.

7. The lure of claim 1, further including a first barb coupled to and extending from the hook distal to the mouth end of the shell wherein the first barb is configured for coupling to the target fish for retaining the target fish on the hook.

8. The lure of claim 1, further including a plurality of retainer barbs coupled to and extending from the hook proximate to the mouth end of the shell wherein the retainer barbs are configured for retaining the bait on the hook proximate to the mouth end of the shell.

9. The lure of claim 1, further including a pair of protrusions coupled to the shell, each protrusion being positioned on a respective opposing side of the shell proximate to the mouth end, the protrusions being arcuate wherein the protrusions are configured for mimicking eyes of a fish.

10. The lure of claim 9, further including the protrusions being red colored wherein the protrusions are configured for agitating the target fish.

11. A fishing lure comprising:
a shell defining an interior space, the shell being fish shaped, the shell being water tight such that the shell is buoyant wherein the shell is configured for floating above objects positioned on a bed of a body of water, the shell comprising at least one of paint, shellac, and plastic, the shell being at least one of brightly colored and reflective such that the shell is configured for attracting a target fish, the shell being at least one of white colored, silver colored, yellow colored, blue colored, violet colored, and green colored;
a filler positioned in and substantially occupying the interior space, the filler comprising rigid foamed elastomer such that the shell is buoyant wherein the shell is configured for floating above the objects positioned on the bed of the body of water;
a ring coupled to and extending from a tail end of the shell wherein the ring is configured for coupling the shell to a leader;
a hook coupled to and extending from a mouth end of the shell such that the hook is configured for coupling to a bait and for hooking the target fish;
a shank positioned through the shell, the shank being coupled to and extending between the hook and the ring;
a first barb coupled to and extending from the hook distal to the mouth end of the shell wherein the first barb is configured for coupling to the target fish for retaining the target fish on the hook;
a plurality of retainer barbs coupled to and extending from the hook proximate to the mouth end of the shell wherein the retainer barbs are configured for retaining the bait on the hook proximate to the mouth end of the shell; and
a pair of protrusions coupled to the shell, each protrusion being positioned on a respective opposing side of the shell proximate to the mouth end, the protrusions being arcuate wherein the protrusions are configured for mimicking eyes of a fish, the protrusions being red colored wherein the protrusions are configured for agitating the target fish.
